(19) United States
(12) Patent Application Publication
(10) Pub. No.: US 2024/0035815 A1
(43) Pub. Date: Feb. 1, 2024

(54) AIR-CONDITIONING APPARATUS

(71) Applicant: Mitsubishi Electric Corporation, Tokyo (JP)

(72) Inventor: Yasuhiko TANAKA, Tokyo (JP)

(21) Appl. No.: 18/257,319

(22) PCT Filed: Mar. 3, 2021
(86) PCT No.: PCT/JP2021/008146

§ 371 Date: Jun. 14, 2023

(51) Int. Cl. G01B 21/02; F24F 1/32; F24F 11/89

(52) U.S. Cl. CPC G01B 21/02; F24F 1/32; F24F 11/89

(57) ABSTRACT

An air-conditioning apparatus includes an outdoor unit, at least one indoor unit connected to the outdoor unit by a refrigerant pipe, a transmission line provided to extend along the refrigerant pipe, and a measuring device that measures a length of the refrigerant pipe from the outdoor unit to the at least one indoor unit, based on an indoor unit signal for measurement of the length of the refrigerant pipe that is transmitted from the at least one indoor unit through the transmission line.

### CROSS REFERENCE TO RELATED APPLICATION

This application is a U.S. national stage application of PCT/JP2021/008146 filed on Mar. 3, 2021, the contents of which are incorporated herein by reference.

### TECHNICAL FIELD

The present disclosure relates to an air-conditioning apparatus capable of measuring the length of a refrigerant pipe or refrigerant pipes that connect an outdoor unit and an indoor unit.

### BACKGROUND

In the case of using an air-conditioning apparatus, it is necessary to fill a proper amount of refrigerant into the air-conditioning apparatus. When the amount of refrigerant in the air-conditioning apparatus is larger or smaller than the proper amount of refrigerant, the air-conditioning apparatus cannot ensure a necessary cooling capacity. Inevitably, the air-conditioning apparatus cannot sufficiently cool a target space or object to be cooled. Therefore, in the case of filling refrigerant into the air-conditioning apparatus, it is necessary to fill a proper amount of refrigerant that depends on the length of a refrigerant pipe or refrigerant pipes.

However, it is very difficult to correctly calculate the length of the refrigerant pipe or pipes, since it cannot be ensured that the refrigerant pipes are arranged as indicated in a design drawing, due to a structure issue of a building.

With respect to the calculation of the length of a refrigerant pipe, for example, in Patent Literature 1 proposes the following technique as a technique of calculating the length of the refrigerant pipe. A transmission module and a plurality of reception modules are attached to respective parts of the refrigerant pipe that are determined in advance. The transmission module gives vibration to the refrigerant pipe, and the reception modules detects the vibration. The length of each of the above parts of the refrigerant pipe is measured from a propagation time determined from time at which the vibration given by the transmission module is detected by an associated one of the reception modules, and the length of the refrigerant pipe is calculated based on a predetermined algorithm.

### PATENT LITERATURE

Patent Literature 1: Japanese Unexamined Patent Application Publication No. 2007-85892

In an existing system described in Patent Literature 1, in order to calculate the length of the refrigerant pipe, it is necessary to attach the transmission module and the reception modules to the refrigerant pipe. Inevitably, it costs a lot of money to prepare the transmission module and the reception modules and to ask a worker to attach the transmission module and the reception modules to the refrigerant pipe.

### SUMMARY

The present disclosure is applied in view of the above circumstances, and relates to an air-conditioning apparatus that can measure the length of a refrigerant pipe or refrigerant pipes by an inexpensive method.

An air-conditioning apparatus according to an embodiment of the present disclosure includes: an outdoor unit; at least one indoor unit connected to the outdoor unit by a refrigerant pipe; a transmission line provided to extend along the refrigerant pipe; and a measuring device configured to measure a length of the refrigerant pipe from the outdoor unit to the at least one indoor unit, based on an indoor unit signal for measurement of the length of the refrigerant pipe that is transmitted from the at least one refrigerant pipe through the transmission line.

According to the embodiment of the present disclosure, the transmission line is provided to extend along the refrigerant pipe. The measuring device measures the length of the refrigerant pipe from the outdoor unit to the at least one indoor unit based on the indoor unit signal. Thus, the air-conditioning apparatus can measure the length of the refrigerant pipe by an inexpensive method without the need to provide a transmission module that gives vibration to the refrigerant pipe and reception modules.

### BRIEF DESCRIPTION OF DRAWINGS

FIG. 1 is a schematic view illustrating a configuration of an air-conditioning apparatus according to an embodiment of the present disclosure.

FIG. 2 illustrates a data structure of a signal which is transmitted/received through a transmission line in the air-conditioning apparatus according to the embodiment.

FIG. 3 is a configuration diagram illustrating a configuration of an outdoor unit in the air-conditioning apparatus according to the embodiment.

FIG. 4 is a configuration diagram illustrating a configuration of an indoor unit in the air-conditioning apparatus according to the embodiment.

FIG. 5 is a configuration diagram illustrating a configuration of a remote controller in the air-conditioning apparatus according to the embodiment.

FIG. 6 is a view related to construction of a refrigerant pipe and a transmission line in the air-conditioning apparatus according to the embodiment.

FIG. 7 illustrates fixation of the refrigerant pipe and the transmission line by a holder in the air-conditioning apparatus according to the embodiment.

FIG. 8 is a flowchart in the case where the outdoor unit calculates the length of the refrigerant pipe in the air-conditioning apparatus according to the embodiment.

FIG. 9 is a view indicating details of time that is required from time at which the outdoor unit in the air-conditioning apparatus according to the embodiment transmits a signal to time at which the outdoor unit receives another signal which is a reply to the transmitted signal.

FIG. 10 illustrates a communication sequence for calculation of the length of the refrigerant pipe in the air-conditioning apparatus according to the embodiment.

FIG. 11 illustrates a display image on a display of a remote controller which has received a signal, in the air-conditioning apparatus according to the embodiment.

FIG. 12 illustrates how a measuring device in an air-conditioning apparatus according to Modification 1 of the embodiment is operated in order to measure a pipe length between an outdoor unit and an indoor unit.

FIG. 13 illustrates an outdoor unit, a branch unit, and indoor units in an air-conditioning apparatus according to Modification 2 of the embodiment.

FIG. 14 is an explanatory view for an operation that is performed in the case where the outdoor unit measures pipe lengths from the outdoor unit to the indoor units in the air-conditioning apparatus according to Modification 2 of the embodiment.

FIG. 15 illustrates an example of an image displayed on a display of a remote controller in the air-conditioning apparatus according to Modification 2 of the embodiment.

### DETAILED DESCRIPTION

An air-conditioning apparatus according to an embodiment of the present disclosure will be described with reference to the drawings. Descriptions of the present disclosure that relate to the embodiment are not limiting, and various modifications can be made without departing from the gist of the present disclosure. Furthermore, the present disclosure encompasses all combinations of combinable ones of configurations that will be described below with respect to the embodiment. In each of figures in the drawings, components that are the same as or equivalent to those of a previous figure or previous figures are denoted by the same reference signs. The same is true of the entire text of the present specification. In addition, in the following description regarding the embodiment, a plurality of components that are of the same kind are distinguished from each other by suffixes; however, in the case where those components are described together, or one of the components is escribed as a representative of the components, the suffixes are omitted.

### Embodiment

An air-conditioning apparatus according to an embodiment will be described.

### Configuration of Air-Conditioning Apparatus

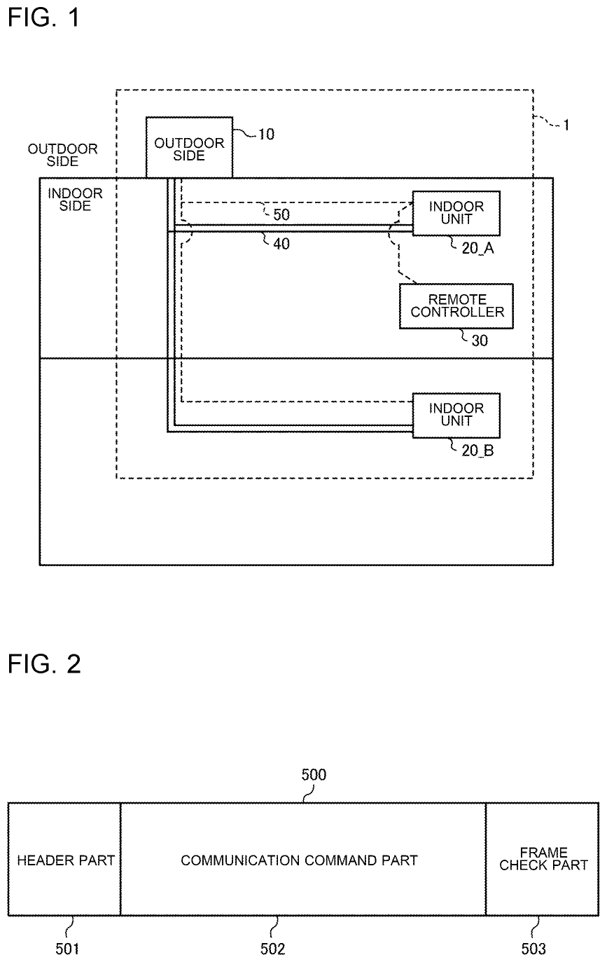

FIG. 1 is a schematic view illustrating a configuration of an air-conditioning apparatus 1 according to the embodiment. The air-conditioning apparatus 1 includes an outdoor unit an indoor unit 20_A, an indoor unit 20_B, and a remote controller 30. FIG. 1 illustrates the case where the air-conditioning apparatus 1 includes a single outdoor unit 10, two indoor units 20_A and 20_B, and a single remote controller 30. The outdoor unit 10 and the indoor unit 20_A are connected, and the outdoor unit 10 and the indoor unit 20_B are connected, by respective refrigerant pipes 40. The outdoor unit 10, the indoor unit 20_A, and the indoor unit 20_B form a refrigerant circuit. In the refrigerant circuit, refrigerant such as R32 or R410A is circulated.

The remote controller 30 transmits through transmission lines 50, a control signal to control the outdoor unit 10, the indoor unit 20_A, and the indoor unit 20_B. The remote controller 30 is placed in an indoor space which is an air-conditioning target space, and is operated by a user.

That is, the outdoor unit 10 is electrically connected to the indoor unit 20_A, the indoor unit 20_B, and the remote controller 30, which is a peripheral device, by the transmission lines 50.

It should be noted that the number of outdoor units 10, that of indoor units 20, and that of remote controller 30 are not limited to those in an example illustrated in FIG. 1, and may each be an arbitrary number.

### Data Structure of Signal

Next, a data structure of a signal 500 which is transmitted/received by each of devices through the transmission line 50 will be described. The devices are the outdoor unit 10, the indoor unit 20, and the remote controller 30, which are connected to the transmission lines 50. FIG. 2 illustrates the data structure of the signal 500 which is transmitted/received through the transmission lines 50 in the air-conditioning apparatus 1 according to the embodiment. As illustrated in FIG. 2, the signal 500 has a header part 501, a communication command part 502, and a frame check part 503. A control signal and various data that are transmitted/received through the transmission lines 50 have such a data structure as illustrated in FIG. 2.

The header part 501 of the signal 500 includes address information, such as a transmission-side address and a reception-side address, for identifying a device that transmits the signal and a device that receives the signal. Furthermore, the header part 501 also includes, for example, information indicating the length of a telegraphic message. The transmission-side address may designate a specific device only, or may designate all devices connected to the transmission lines 50.

The communication command part 502 of the signal 500 includes the contents of a communication command, and is referred to as a payload. To be more specific, the communication command part 502 is information, such as a command to monitor the state of a device, or a command to control the operation of a device.

The frame check part 503 of the signal 500 includes a code, such as an error correction code for detection of a transmission error at the time of transmitting/receiving the signal 500.

### Configuration of Outdoor Unit

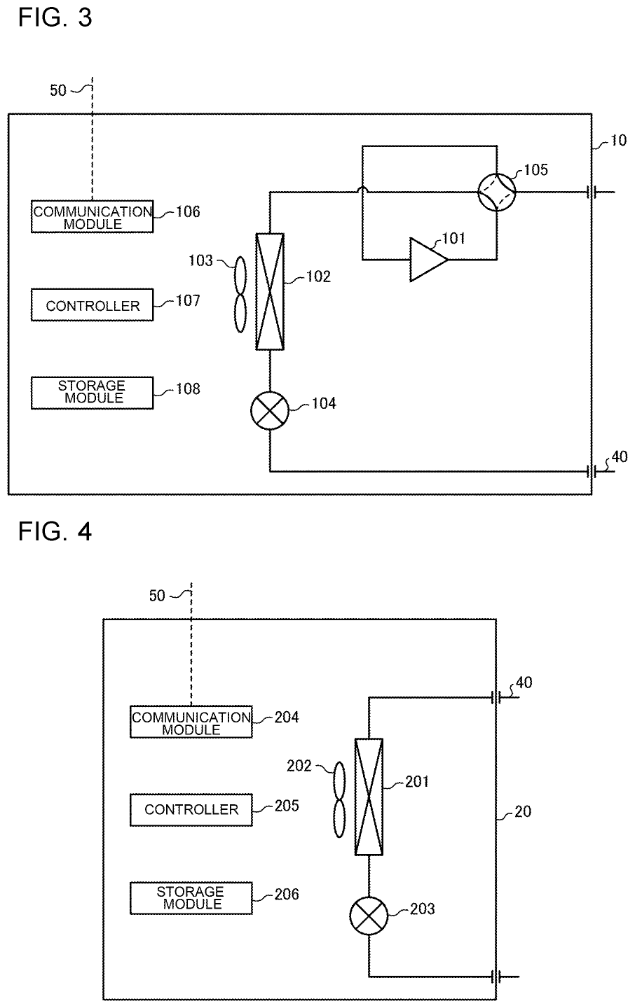

Next, a configuration of the outdoor unit 10 will be described. FIG. 3 is a configuration diagram illustrating a configuration of the outdoor unit 10 in the air-conditioning apparatus 1 according to the embodiment. The outdoor unit 10 is installed outside an indoor space which is an air-conditioning target space. The outdoor unit 10 includes a compressor 101, a heat-source-side heat exchanger 102, an outdoor-unit fan 103, an outdoor-unit expansion valve 104, and a flow switching device 105. The outdoor unit 10 further includes a communication module 106, a controller 107, and a storage module 108. In the outdoor unit 10, the compressor 101, the heat-source-side heat exchanger 102, the outdoor-unit expansion valve 104, and the flow switching device 105 are connected by the refrigerant pipe 40.

The compressor 101 compresses sucked refrigerant into high-temperature and high-pressure refrigerant, and discharges the high-temperature and high-pressure refrigerant. The compressor 101 is, for example, an inverter compressor which is controlled by an inverter not illustrated. In the case where the compressor 101 is an inverter compressor, in the compressor 101, it is possible to change the capacity of the compressor 101 by arbitrarily changing an operating frequency thereof. This capacity is the amount of refrigerant which the compressor delivers per unit time.

The heat-source-side heat exchanger 102, for example, causes heat exchange to be performed between air and refrigerant that passes through the heat-source-side heat exchanger 102.

The outdoor-unit fan 103 is provided to face the heat-source-side heat exchanger 102. The outdoor-unit fan 103 sends air to the heat-source-side heat exchanger 102. When the outdoor-unit fan 103 operates, air for heat exchange with the refrigerant is sent to the heat-source-side heat exchanger 102.

The outdoor-unit expansion valve 104 reduces the pressure of the refrigerant. The outdoor-unit expansion valve 104 is, for example, an electric expansion valve whose opening degree can be adjusted.

The flow switching device 105 is, for example, a four-way valve. The flow switching device 105 switches a flow passage in the refrigerant circuit. For example, in a cooling operation in which the indoor unit 20 performs cooling, the state of the flow switching device 105 is switched to a state indicated by solid lines in FIG. 3, the heat-source-side heat exchanger 102 serves as a condenser, and a use-side heat exchanger 201, which will be described later, serves as an evaporator. Furthermore, for example, in a heating operation in which the indoor unit 20 performs heating, the state of the flow switching device 105 is switched to a state indicated by broken lines in FIG. 3, the heat-source-side heat exchanger 102 serves as an evaporator, and the use-side heat exchanger 201 serves as a condenser.

The communication module 106 transmits/receives a control signal or various data to/from the indoor unit 20 and the remote controller 30 through the transmission lines 50. The communication module 106 performs both transmission and reception, and thus serves as both a transmission module and a reception module. The communication module 106 is made of a transmission circuit and a reception circuit, or is made of a transmission and reception circuit.

The controller 107 controls components of the outdoor unit 10, for example, controls the frequency of the compressor 101 and the rotation speed of the outdoor-unit fan 103. Functions of the controller 107 is fulfilled by a processing circuit. The processing circuit may be dedicated hardware or a processor that executes a program stored in a memory.

The storage module 108 is a non-volatile or volatile semiconductor memory, such as a RAM, a ROM, a flash memory, an EPROM, or an EEPROM. The storage module 108 stores data included in a control signal received through the communication module 106 and the result of a calculation by the controller 107.

In the case where the processing circuit of the controller 107 is dedicated hardware, the processing circuit corresponds to, for example, a single-component circuit, a composite circuit, an application specific integrated circuit (ASIC), a field programmable gate array (FPGA), or a combination of these circuits. The functions that are fulfilled by the processing circuit may be fulfilled by respective hardware or single hardware. In the case where the processing circuit of the controller 107 is a CPU, the functions that are fulfilled by the processing circuit are fulfilled by software, firmware or a combination of software and firmware. The software and firmware are written as programs and stored in the storage module 108. The CPU reads out a program from the storage module 108 and executes the program, thereby fulfilling an associated function of the processing circuit. It should be noted that some of the functions of the processing circuit may be fulfilled by dedicated hardware, and some others of the functions of the processing circuit may be fulfilled by software or firmware.

### Configuration of Indoor Unit

A configuration of the indoor unit 20 will be described. Since the indoor unit 20_A and the indoor unit 20_B have the same configuration, each of them will be described as the indoor unit 20. FIG. 4 is a configuration diagram illustrating the configuration of the indoor unit 20 in the air-conditioning apparatus 1 according to the embodiment. The indoor unit 20 includes the use-side heat exchanger 201, an indoor-unit fan 202, and an indoor-unit expansion valve 203. The indoor unit 20 further includes a communication module 204, a controller 205, and a storage module 206. It should be noted that as illustrated in FIG. 1, in each of the indoor units 20_A and 20_B, the use-side heat exchanger 201 and the indoor-unit expansion valve 203 are connected to the outdoor unit 10 by the refrigerant pipe 40.

The use-side heat exchanger 201 causes heat exchange to be performed, for example, between air and refrigerant that passes through the use-side heat exchanger 201.

The indoor-unit fan 202 is provided to face the use-side heat exchanger 201. The indoor-unit fan 202 sends air to the use-side heat exchanger 201. When the indoor-unit fan 202 operates, air for exchange with the refrigerant is sent to the use-side heat exchanger 201. As a result, conditioned air subjected to heat exchange at the use-side heat exchanger 201 is supplied into the indoor space.

The indoor-unit expansion valve 203 reduces the pressure of the refrigerant. The indoor-unit expansion valve 203 is, for example, an electric expansion valve whose opening degree can be adjusted.

The communication module 204 transmits/receives a control signal to/from the devices of the air-conditioning apparatus 1 through the transmission lines 50. The communication module 204 performs both transmission and reception, and thus serves as a transmission module and a reception module. Therefore, the communication module 204 is made of a transmission circuit and a reception circuit, or is made of a transmission and reception circuit.

The controller 205 controls components of the indoor unit 20, for example, controls the rotation speed of the indoor-unit fan 202 and the opening degree of the indoor-unit expansion valve 203. Functions of the controller 205 are fulfilled by a processing circuit. The processing circuit may be dedicated hardware or a processor that executes a program stored in a memory.

The storage module 206 is a volatile or non-volatile semiconductor memory such as a RAM, a ROM, a flash memory, an EPROM, or an EEPROM. The storage module 206 stores data included in a control signal received through the communication module 204 and the result of a calculation by the controller 205. Furthermore, in the case where the indoor unit 20 includes a temperature sensor that detects an indoor temperature and a refrigerant sensor that detects a leak of refrigerant, the results of detection by the temperature sensor and the refrigerant sensor are also stored in the storage module 206.

In the case where the processing circuit of the controller 205 is dedicated hardware, the processing circuit corresponds to, for example, a single-component circuit, a composite circuit, an application specific integrated circuit (ASIC), a field programmable gate array (FPGA), or a combination of these circuits. The functions that are fulfilled by the processing circuit may be fulfilled by respective hardware or single hardware. In the case where the processing circuit of the controller 205 is a CPU, the functions that are fulfilled by the processing circuit are fulfilled by software, firmware or a combination of software and firmware. The software and firmware are written as programs and stored in the storage module 206. The CPU reads out a program from the storage module 206 and executes the program, thereby fulfilling an associated function of the processing circuit. It should be noted that some of the functions of the processing circuit may be fulfilled by dedicated hardware, and some others of the functions of the processing circuit may be fulfilled by software or firmware.

### Configuration of Remote Controller

A configuration of the remote controller 30 in the air-conditioning apparatus 1 will be described.

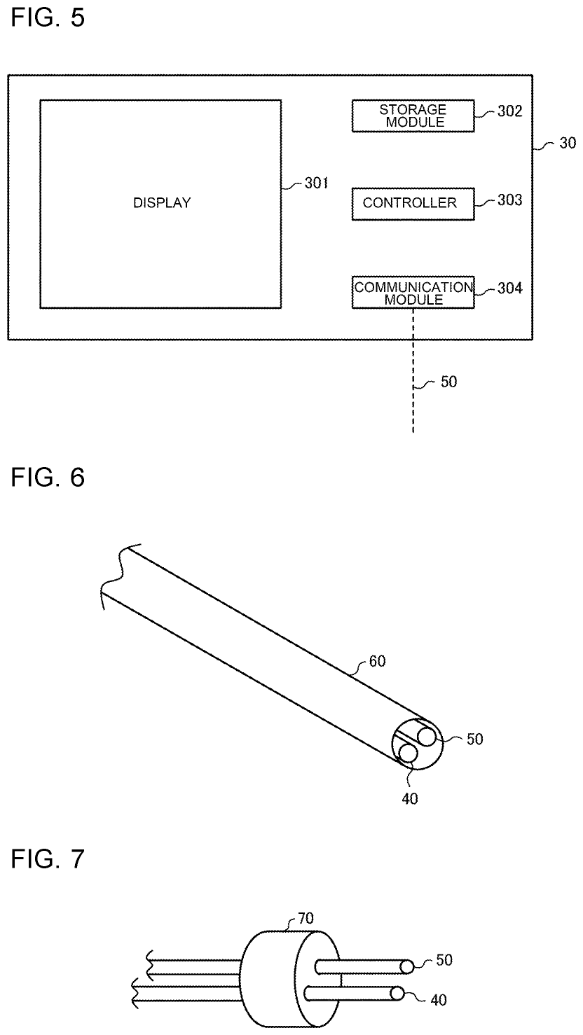

FIG. 5 is a configuration diagram illustrating a configuration of the remote controller in the air-conditioning apparatus 1 according to the embodiment. The remote controller includes a display 301, a storage module 302, a controller 303, and a communication module 304.

The display 301 of the remote controller 30 is, for example, a touch panel. The display 301 displays information on the air-conditioning apparatus 1 that is obtained by the remote controller 30. Furthermore, the display 301 can be operated by a user. The user inputs a request indicating an operation to be performed by the air-conditioning apparatus 1, using an editing area, an input window, etc., displayed on a screen of the display 301. It should be noted that although it is described above that the display 301 is a touch panel, it is not limiting. The display 301 may be made up of a display device such as a liquid crystal display screen and an input device such as operation buttons.

The storage module 302 of the remote controller 30 is a non-volatile or volatile semiconductor memory such as a RAM, a flash memory, an EPROM, or an EEPROM. The storage module 302 stores operation details input by the user using the display 301, data included in a control signal transmitted/received via the communication module 304, and the result of a calculation by the controller 303.

The controller 303 of the remote controller 30 controls the display 301, the storage module 302, and the communication module 304. The controller 303 processes, for example, the operation details input by the user and the data included in the control signal received via the communication module 304, and controls the operation of the air-conditioning apparatus 1 to be controlled, based on the result of the processing by the controller 303. Functions of the controller 303 are fulfilled by the processing circuit. The processing circuit may be dedicated hardware or a processor that executes a program.

In the case where the processing circuit of the controller 303 is dedicated hardware, the processing circuit corresponds to, for example, a single-component circuit, a composite circuit, an application specific integrated circuit (ASIC), a field programmable gate array (FPGA), or a combination of these circuits. Functions that are fulfilled by the processing circuit may be fulfilled by respective hardware or single hardware. In the case where the processing circuit of the controller 303 is a CPU, the functions that are fulfilled by the processing circuit are fulfilled by software, firmware, or a combination of software and firmware. The software and the firmware are written as programs and stored in the storage module 302. The CPU reads out a program from the storage module 302 and executes the program, thereby fulfilling an associated function of the processing circuit. It should be noted that some of the functions of the processing circuit may be fulfilled by dedicated hardware and some other of the functions may be fulfilled by software or firmware.

The communication module 304 of the remote controller 30 transmits/receives a signal 500 through the transmission line 50. The communication module 304 performs both transmission and reception, and thus serves as both a transmission module and a reception module. Therefore, the communication module 304 is made of a transmission circuit and a reception circuit or is made of a transmission and reception circuit. Furthermore, the communication module 304 communicates with each of components in the air-conditioning apparatus 1. In this case, the communication module 304 may wirelessly communicate with all the above components or some of the components in the air-conditioning apparatus 1. Furthermore, a communication protocol of communication that is performed through the transmission line 50 is not limited to a specific one.

Next, construction of the outdoor unit 10, the indoor unit 20, and the remote controller 30 will be described. FIG. 6 is a view related to construction of the refrigerant pipe 40 and the transmission line 50 in the air-conditioning apparatus 1 according to the embodiment. The refrigerant pipe 40 and the transmission line 50 are enveloped in the heat insulating material 60. To be more specific, a worker envelops the refrigerant pipe 40 in the heat insulating material 60 in order to keep heat of refrigerant in the refrigerant pipe 40. At this time, the worker envelops the transmission line 50 along with the refrigerant pipe 40 in the heat insulating material 60.

The worker sets the transmission line 50 along the refrigerant pipe 40 such that the transmission line 50 is not loosened in the heat insulating material 60. FIG. 7 illustrates fixation of the refrigerant pipe 40 and the transmission line 50 by a holder 70 in the air-conditioning apparatus 1 according to the embodiment. The holder 70 is a member that fixes the refrigerant pipe 40 and the transmission line 50 to each other.

When the construction is carried out using members as illustrated in FIGS. 6 and 7, the length of the refrigerant pipe 40 and that of the transmission line 50 can be made nearly equal to each other.

### Calculation Processing for Pipe Length

Next, a series of processes that are executed when the outdoor unit 10 calculates the length of the refrigerant pipe 40 will be described.

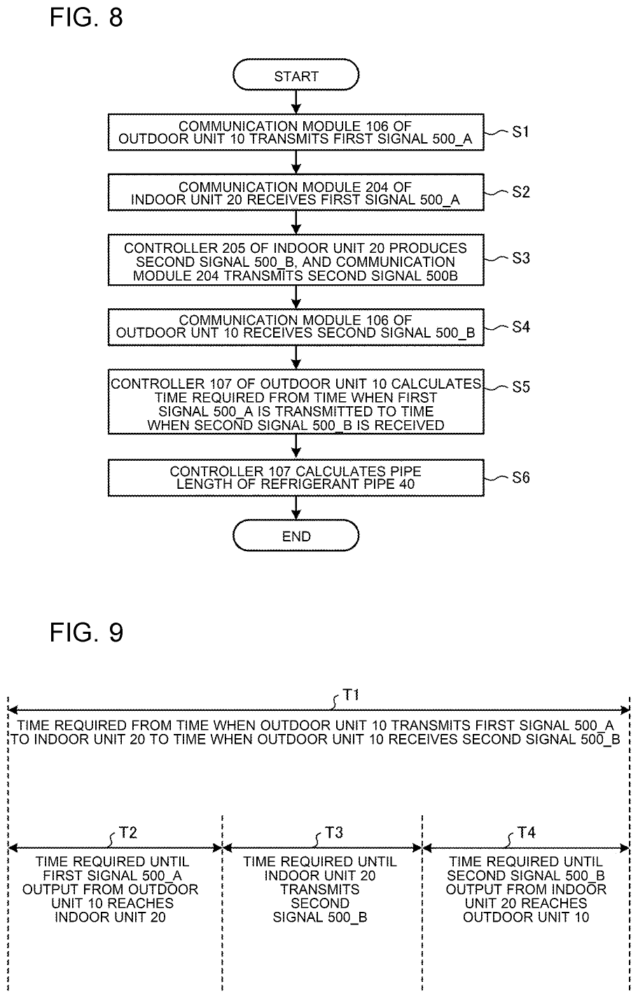

FIG. 8 is a flowchart in the case where the outdoor unit 10 calculates the length of the refrigerant pipe 40 in the air-conditioning apparatus 1 according to the embodiment. Because of a communication sequence as indicated in FIG. 8, the outdoor unit 10 can calculates the length of the refrigerant pipe 40.

In step S1, the controller 107 of the outdoor unit 10 produces a first signal 500_A. In the header part 501, address information on the outdoor unit 10 is set as a transmission-side address, and address information on the indoor unit 20 is set as a reception-side address.

The controller 107 sets in the communication command part 502, an identifier indicating that the first signal 500_A which is transmitted by the outdoor unit 10 is transmitted to calculate the length of the refrigerant pipe 40.

The controller 107 causes the communication module 106 to transmit the first signal 500_A through the transmission line 50. The controller 107 stores data indicating time at which the signal 500_A is transmitted, in the storage module 108.

In step S2, the communication module 204 of the indoor unit 20 receives the first signal 500_A. The communication module 204 of the indoor unit 20 analyzes the transmission-side address in the header part 501 and recognizes that the first signal 500_A is transmitted to the indoor unit 20 itself.

The communication module 204 forwards the contents of the communication command part 502 to the controller 205. The controller 205 analyzes the communication command part 502 to recognize that the first signal 500_A is transmitted to calculate the length of the refrigerant pipe 40.

In step S3, the controller 205 of the indoor unit 20 produces a second signal 500_B. The controller 205 sets address information on the indoor unit 20 as a transmission-side address, and address information on the outdoor unit 10 as a reception-side address, in the header part 501.

The controller 205 sets in the communication command part 502, an identifier indicating that the second signal 500_B is a reply to the first signal 500_A and time required until the second signal 500_B is produced. After the above setting, the controller 205 causes the communication module 204 to transmit the second signal 500_B through the transmission line 50.

In step S4, the communication module 106 of the outdoor unit 10 receives the second signal 500_B, analyzes the reception-side address in the header part 501, and recognizes that the second signal 500_B is transmitted to the outdoor unit 10.

The communication module 106 forwards the contents of the communication command part 502 to the controller 107. The controller 107 analyzes the communication command part 502 and recognizes that the second signal 500_B is a reply to the first signal 500_A.

In step S5, the controller 107 of the outdoor unit 10 calculates time that is required from time at which the first signal 500_A is transmitted to time at which the second signal 500_B which is a reply to the first signal 500_A is received.

In step S6, the controller 107 of the outdoor unit 10 calculates the length of the refrigerant pipe 40 based on the time calculated in step S6.

Next, step S5 as indicated in FIG. 8 will be described in further detail with reference to FIG. 9. FIG. 9 is a view indicating details of time that is required from time at which the outdoor unit 10 in the air-conditioning apparatus 1 according to the embodiment transmits the first signal 500_A to time at which the outdoor unit 10 receives the second signal 500_B which is a reply to the first signal 500_A. The details of the step S5 will be described in detail with reference to FIG. 9.

Time T1 as indicated in FIG. 9 is time required from time at which the outdoor unit 10 transmits the first signal 500_A to the indoor unit 20 to time at which the outdoor unit 10 receives the second signal 500_B. The controller 107 calculates the time T1 by subtracting time at which the controller 107 transmits the first signal 500_A stored in the storage module 108 from time at which the outdoor unit 10 receives the second signal 500_B.

Time T2 is time required until the first signal 500_A output from the outdoor unit 10 reaches the indoor unit 20. Time T4 is time required until the second signal 500_B output from the indoor unit 20 reaches the outdoor unit 10. It can be assumed that the time T2 and the time T4 are equal to each other (T2=T4), in the case where the outdoor unit 10 and the indoor unit 20 use the same communication method to communicate with each other, and a disturbance factor such as noise is not present.

Time T3 is the total time of time required for the controller 205 of the indoor unit 20 to produce a second signal 500_B and time required until the controller 205 transmits the second signal 500_B to the outdoor unit 10 after producing the second signal 500_B. The time T3 is time set in the communication command part 502 of the second signal 500_B.

As described above, it can be assumed that T2=T4, and the following equation (1) is thus satisfied.

T2=(T1−T3)/2 (1)

The controller 107 of the outdoor unit 10 can determine, as the time T3, the time set in the communication command part 502 of the second signal 500_B. Therefore, using the above equation (1), it is possible to calculate time required until the first signal 500_A from the outdoor unit 10 reaches the indoor unit 20_A.

The length of the transmission line 50 between the outdoor unit 10 and the indoor unit can be calculated from the equation “L1=V×T2”, where L1 is the length of the transmission line 50 between the outdoor unit 10 and the indoor unit 20, V is the velocity of the first signal 500_A, and T2 is time required until the first signal 500_A from the outdoor unit 10 reaches the indoor unit 20_A.

In step S6, as described above, since the length of the refrigerant pipe 40 and the length of the transmission line 50 are nearly equal to each other; that is, the length of the refrigerant pipe 40≈L1, the controller 107 of the outdoor unit 10 can calculate the length of the refrigerant pipe 40.

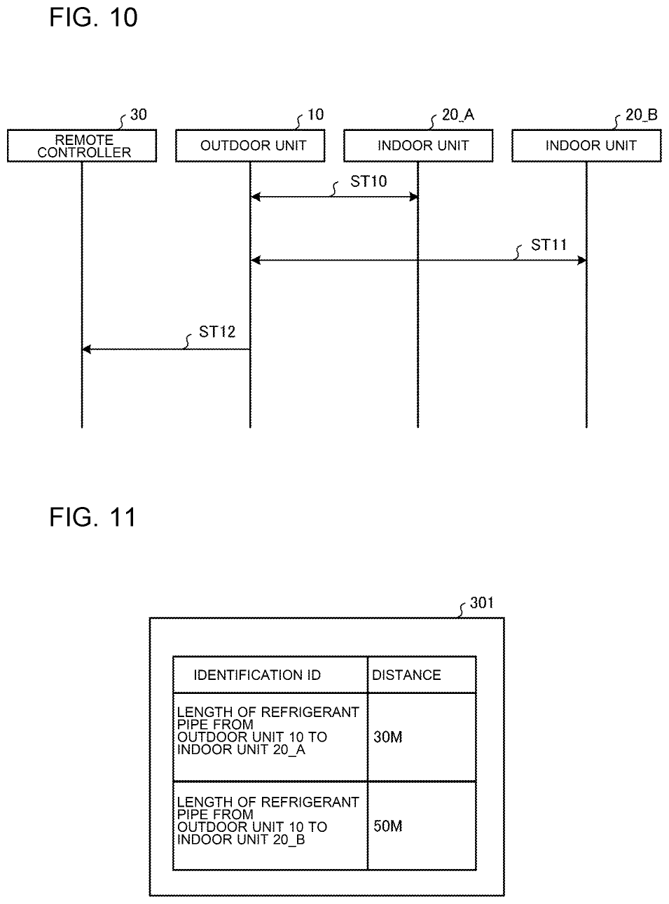

FIG. 10 illustrates a communication sequence for calculation of the length of the refrigerant pipe 40 in the air-conditioning apparatus 1 according to the embodiment.

At timing ST10, the controller 107 of the outdoor unit 10 executes the processing as indicated in the flowchart of FIG. 8, thereby calculating the length of the refrigerant pipe 40 from the outdoor unit 10 to the indoor unit 20_A.

At timing ST11, the controller 107 of the outdoor unit 10 executes the processing as indicated in the flowchart of FIG. 8, thereby calculating the length of the refrigerant pipe 40 from the outdoor unit 10 to the indoor unit 20_B.

At timing ST12, the controller 107 of the outdoor unit 10 produces a third signal 500_C. The controller 107 sets address information on the outdoor unit 10 as a transmission-side address for the third signal 500_C and address information on the remote controller 30 as a reception-side address for the third signal 500_C, in the header part 501.

The controller 107 sets the length of the refrigerant pipe 40 located from the outdoor unit 10 to the indoor unit 20_A and the length of the refrigerant pipe 40 located from the outdoor unit 10 to the indoor unit 20_B, as signals indicating those lengths, in the communication command part 502 of the third signal 500_C.

The controller 107 of the outdoor unit 10 causes the communication module 106 to transmit the third signal 500_C through the transmission line 50.

FIG. 11 illustrates a display image on the display 301 of the remote controller 30 which has received the third signal 500_C, in the air-conditioning apparatus 1 according to the embodiment.

The remote controller 30 reads out the length of the refrigerant pipe 40 from the communication command part 502 of the third signal 500_C, and causes display 301 to display the length of the refrigerant pipe 40. In an example illustrated in FIG. 11, the display 301 indicates that the length of the refrigerant pipe 40 from the outdoor unit 10 to the indoor unit 20_A is 30 m and the length of the refrigerant pipe 40 from the outdoor unit 10 to the indoor unit 20_B is 50 m.

Therefore, in the air-conditioning apparatus 1 according to the embodiment, one or more indoor units 20 transmits a second signal 500_B upon reception of a first signal 500_A transmitted from the outdoor unit 10. The outdoor unit 10 measures the length of the refrigerant pipe or pipes 40 from the outdoor unit 10 to the one or more indoor units 20, based on the second signal 500_B transmitted from the one or more indoor units 20. Therefore, the air-conditioning apparatus 1 can measure the length of the refrigerant pipe or pipes by an inexpensive method without the need to provide a transmission module that gives vibration to the refrigerant pipe 40 and reception modules.

### Modification 1

Regarding the above embodiment, it is described above by way of example that the outdoor unit 10 measures the pipe length. However, a measuring device 601 that measures the pipe length is not limited to the outdoor unit 10; that is, the kind of a device that is applied as the measuring device is not limited.

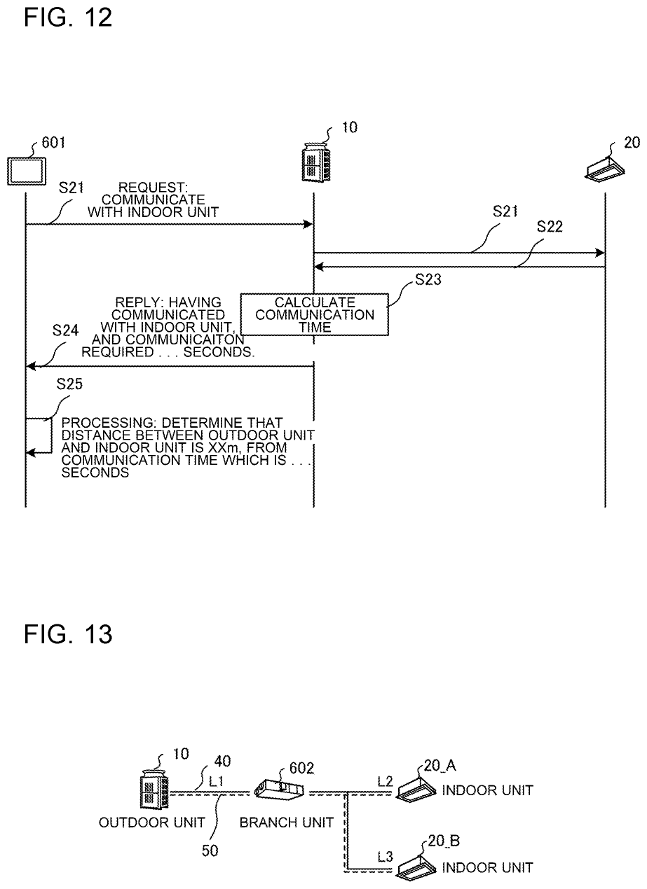

FIG. 12 illustrates how the measuring device 601 in the air-conditioning apparatus 1 according to Modification 1 of the embodiment is operated in order to measure a pipe length between the outdoor unit 10 and the indoor unit 20. The measuring device 601 may be, for example, the indoor unit 20, the remote controller 30, a branch unit, or a personal computer.

Furthermore, a method of measuring the pipe length is applied on the premise that time set in the outdoor unit 10 coincides with that set in the indoor unit 20.

As illustrated in FIG. 12, the measuring device 601 transmits to the outdoor unit 10, a request signal for measurement of communication time between the outdoor unit 10 and the indoor unit 20 (step S21). When receiving the request signal from the measuring device 601, the outdoor unit 10 transmits a request signal which requests an indoor unit signal to the indoor unit 20 (step S21)

When receiving the request signal from the outdoor unit 10, the indoor unit 20 transmits an indoor unit signal to the outdoor unit 10 (step S22). The indoor unit signal includes transmission time that is time at which the indoor unit signal is transmitted from the indoor unit 20.

When receiving the indoor unit signal from the indoor unit 20, the outdoor unit 10 calculates communication time between the outdoor unit 10 and the indoor unit 20 (step S23). To be more specific, the outdoor unit 10 calculates the communication time between the outdoor unit 10 and the indoor unit 20 by subtracting the transmission time from reception time that is time at which the outdoor unit 10 receives the indoor unit signal.

Then, the outdoor unit 10 transmits a reply signal including the calculated communication time to the measuring device 601 (step S24).

The measuring device 601 measures the length of the refrigerant pipe 40 located from the outdoor unit 10 to the indoor unit 20, based on the communication time included in the reply signal (step S25).

### Modification 2

Next, an air-conditioning apparatus 1 according to Modification 2 of the embodiment will be described. In Modification 2, a branch unit 602 is installed between the outdoor unit and the indoor units 20_A and 20_B.

FIG. 13 illustrates the outdoor unit 10, the branch unit 602, the indoor unit 20_A, and the indoor unit 20_B in the air-conditioning apparatus 1 according to Modification 2 of the embodiment.

Referring to FIG. 13, the outdoor unit 10 and the branch unit 602 are connected by a refrigerant pipe 40. Furthermore, the outdoor unit 10 and the branch unit 602 are also connected by a transmission line 50 which extends along the refrigerant pipe 40.

Similarly, the branch unit 602 and the indoor unit 20_A are connected by a refrigerant pipe 40 and a transmission line which extends along the refrigerant pipe 40. Also, the branch unit 602 and the indoor unit 20_B are connected by a refrigerant pipe 40 and a transmission line 50 which extends along the refrigerant pipe 40.

It is assumed that the length of the refrigerant pipe 40 between the outdoor unit 10 and the branch unit 602 is L1 which is a first length; the length of the refrigerant pipe 40 between the branch pipe 602 and each of the indoor units 20 is a second length, and to be more specific, the second length of the refrigerant pipe 40 between the branch unit 602 and the indoor unit 20_A is L2; and the second length of the refrigerant pipe 40 between the branch unit 602 and the indoor unit 20_B is L3.

The branch unit 602 causes refrigerant that flows thereinto from the outdoor unit 10 through the refrigerant pipe 40 to branch into refrigerant that flows into the indoor unit 20_A and refrigerant that flows into the indoor unit 20_B. The refrigerant subjected to heat exchange at the indoor unit 20_A and the refrigerant subjected to heat exchange at the indoor unit 20_B are returned to the outdoor unit 10 by the branch unit 602.

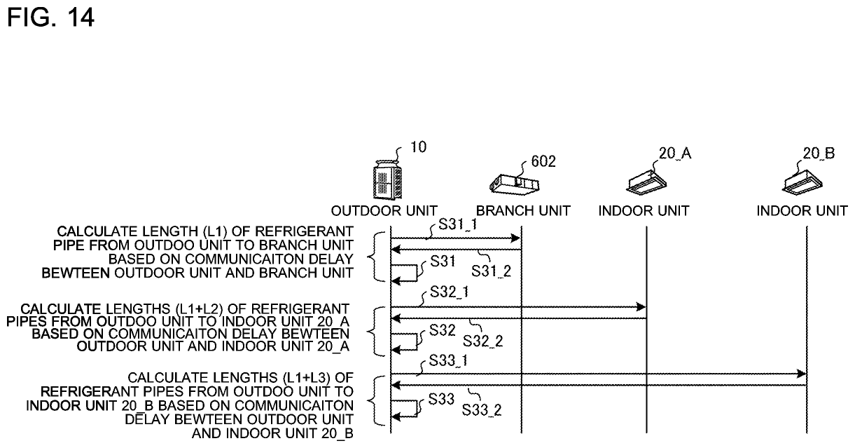

FIG. 14 is an explanatory view for an operation that is performed in the case where the outdoor unit 10 measures a pipe length from the outdoor unit 10 to the indoor unit 20_A and a pipe length from the outdoor unit 10 to the indoor unit 20_B, in the air-conditioning apparatus 1 according to Modification 2 of the embodiment.

The length L1 of the refrigerant pipe 40 between the outdoor unit 10 and the branch unit 602 is calculated based on a communication delay between the outdoor unit 10 and the branch unit 602 as in the method described with respect to the embodiment. The outdoor unit 10 transmits a first signal 500_A to the branch unit 602 (step S31_1), and receives a second signal 500_B from the branch unit 602 (step S31_2). Based on the received second signal 500_B, the outdoor unit 10 calculates the length L1 of the refrigerant pipe 40 between the outdoor unit 10 and the branch unit 602 (step S31).

The outdoor unit 10 calculates the lengths L1 and L2 of the refrigerant pipes 40 between the outdoor unit 10 and the indoor unit 20_A based on a communication delay between the outdoor unit 10 and the indoor unit 20_A as in the method described with respect to the embodiment. To be more specific, the outdoor unit 10 transmits a first signal 500_A to the indoor unit 20_A (step S32_1), and receives a second signal 500_B from the indoor unit 20_A (step S32_2). Based on the received second signal 500_B, the outdoor unit 10 calculates the lengths L1 and L2 of the refrigerant pipes 40 between the outdoor unit 10 and the indoor unit 20_A (step S32).

The outdoor unit 10 calculates the lengths L1 and L3 of the refrigerant pipes 40 between the outdoor unit 10 and the indoor unit 20_B based on a communication delay between the outdoor unit 10 and the indoor unit 20_B as in the method described with respect to the embodiment. To be more specific, the outdoor unit 10 transmits a first signal 500_A to the indoor unit 20_B (step S33_1), and receives a second signal 500_B from the indoor unit 20_B (step S33_2). Based on the received second signal 500_B, the outdoor unit 10 calculates the lengths L1 and L3 of the refrigerant pipes 40 between the outdoor unit 10 and the indoor unit 20_B (step S33).

According to the method described regarding Modification 1 of the embodiment, the outdoor unit 10 may calculate the length L1 of the refrigerant pipe 40 between the outdoor unit 10 and the branch unit 602 based on a branch unit signal which is transmitted from the branch unit 602 to the outdoor unit 10; the outdoor unit 10 may calculate the total length of the lengths L1 and L2 of the refrigerant pipes 40 between the outdoor unit 10 and the indoor unit 20_A based on an indoor unit single which is transmitted from the indoor unit 20_A to the outdoor unit 10; and the outdoor unit 10 may calculate the total length of the length L1 and L3 of the refrigerant pipes 40 between the outdoor unit 10 and the indoor unit 20_B based on an indoor unit single which is transmitted from the indoor unit 20_B to the outdoor unit 10.

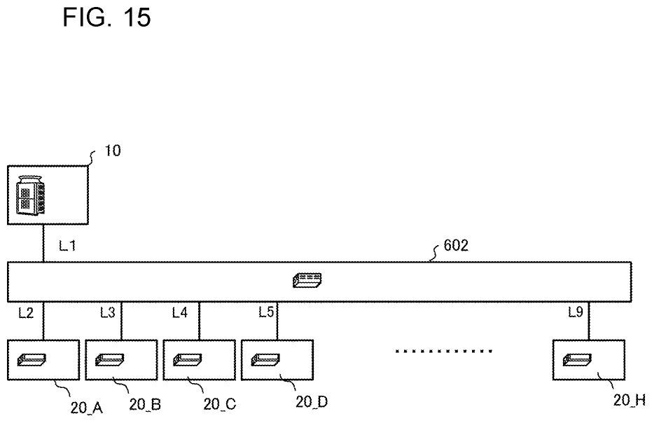

FIG. 15 illustrates an example of an image displayed on the display 301 of the remote controller 30 in the air-conditioning apparatus 1 according to Modification 2 of the embodiment.

FIG. 15 illustrates the case where eight indoor units 20 are connected to the branch unit 602. Also, referring to FIG. 15, L1 is the length of a refrigerant pipe 40 between the outdoor unit 10 and the branch unit 602, and L2 to L9 are the lengths of respective refrigerant pipes between the branch unit 602 and indoor units 20_A to 20_H, respectively.

Since such an image as described above is displayed on the display 301 of the remote controller 30, the user can grasp from the display, the length L1 of the above refrigerant pipe and the lengths L2 to L9 of the above refrigerant pipes 40.

Regarding the above embodiment, the outdoor unit 10, the indoor unit 20, and the remote controller 30 are also referred to as measuring devices 601, and the first signal 500_A, an outdoor unit signal, the second signal 500_B, the indoor unit signal, and the third signal 500_C are also each referred to as a remote controller signal.

In the embodiment, the first signal 500_A and the second signal 500_B are transmitted through the transmission lines which extend along the refrigerant pipes 40. Therefore, the refrigerant pipe 40 and the transmission line 50 which extends along the refrigerant pipe 40 can be made nearly equal to each other.

Furthermore, in the embodiment, using the remote controller 30 for the indoor unit 20 of the air-conditioning apparatus 1, it is possible to cause the display 301 to display the length of the refrigerant pipe 40. Therefore, the length of the refrigerant pipe can be confirmed by an inexpensive method.

The embodiment is described above by way of example, and its description does not intend to limit the claims. Modifications of the embodiment can be made, and various omissions, replacement, and modifications can be made without from departing from the gist of the embodiment. The scope and gist of the embodiment cover the above modifications of the embodiment.

1. An air-conditioning apparatus comprising:
an outdoor unit;
at least one indoor unit connected to the outdoor unit by a refrigerant pipe;
a transmission line provided to extend along the refrigerant pipe; and
a measuring device configured to measure a length of the refrigerant pipe from the outdoor unit to the at least one indoor unit, based on an indoor unit signal for measurement of the length of the refrigerant pipe that is transmitted from the at least one refrigerant pipe through the transmission line,
wherein the outdoor unit is configured to transmit an outdoor unit signal for measurement of the length of the refrigerant pipe to the at least one indoor unit,
the at least one indoor unit is configured to receive the outdoor unit signal transmitted from the outdoor unit, and transmit the indoor unit signal for measurement of the length of the refrigerant pipe upon reception of the outdoor unit signal, and
the measuring device is configured to measure the length of the refrigerant pipe located from the outdoor unit to the at least one indoor unit, based on the indoor unit signal transmitted from the at least one indoor unit.

2. The air-conditioning apparatus of claim 1, wherein
the measuring device is the outdoor unit.

3. The air-conditioning apparatus of claim 2, wherein the outdoor unit signal and the indoor unit signal are transmitted through the transmission line.

4. The air-conditioning apparatus of claim 2, further comprising:
a remote controller including a display,
wherein the outdoor unit is configured to transmit a remote controller signal indicating the measured length of the refrigerant pipe to the remote controller, and
the remote controller is configured to cause the display to display the length of the refrigerant pipe that is indicated by the remote controller signal transmitted from the outdoor unit.

5. The air-conditioning apparatus of claim 4,
the at least one indoor unit is a plurality of indoor units,
the outdoor unit is configured to transmit the remote controller signal indicating the length of the refrigerant pipes located from the outdoor unit to the plurality of indoor units to the remote controller, and
the remote controller is configured to display the length of the refrigerant pipes from the outdoor unit to the plurality of indoor units that is indicated by the remote controller signal transmitted from the outdoor unit.

6. The air-conditioning apparatus of claim 2, wherein
the indoor unit signal includes time T3 that is total time of time required for the at least one indoor unit to produce the indoor unit signal and time required until the at least one indoor unit transmit the indoor unit signal to the outdoor unit after producing the indoor unit signal, and
the outdoor unit is configured to:
calculate time T1 that is time required from time at which the outdoor unit transmits the outdoor unit signal to time at which the outdoor unit receives the indoor unit signal, by subtracting the time at which the outdoor unit transmits the outdoor unit signal from the time at which the outdoor unit receives the indoor unit signal, and
calculate time T2 that is time required until the outdoor unit signal transmitted from the outdoor unit reaches the at least one indoor unit, using the equation “T2=(T1−T3)/2, and
measure the length of the refrigerant pipe located from the outdoor unit to the at least one indoor unit, based on the time T2.

7. The air-conditioning apparatus of claim 1, wherein
the measuring device is the outdoor unit, the remote controller for the indoor unit, or the at least one indoor unit,
the indoor unit signal includes transmission time that is time at which the indoor unit signal is transmitted from the at least one indoor unit,
the outdoor unit is configured to calculate communication time between the outdoor unit and the at least one indoor unit, by subtracting the transmission time from reception time that is time at which the outdoor unit receives the indoor unit, and
the measuring device is configured to measure the length of the refrigerant pipe located from the outdoor unit to the at least one indoor unit, based on the communication time calculated by the outdoor unit.

8. The air-conditioning apparatus of claim 1, wherein
the measuring device is the outdoor unit,
the at least one indoor unit is a plurality of indoor unit,
which further comprises a branch unit configured to cause refrigerant input from the outdoor unit through the refrigerant pipe to branch into refrigerant into the plurality of indoor units, and
wherein the outdoor unit is configured to calculate a first length of the refrigerant pipe between the outdoor unit and the branch unit and a second length of the refrigerant pipe between the branch unit and the at least one indoor unit.

9. The air-conditioning apparatus of claim 8, further comprising:
a remote controller including a display,
wherein the outdoor unit is configured to transmit a remote controller signal indicating the calculated first or second length to the remote controller, and
the remote controller is configured to cause the display to display the first or second length indicated by the remote controller signal transmitted from the outdoor unit.
